(19) United States
(12) Patent Application Publication
(10) Pub. No.: US 2015/0053619 A1
(43) Pub. Date: Feb. 26, 2015

(54) Process for Hardness and Boron Removal

(71) Applicant: Baker Hughes Incorporated, Houston, TX (US)

(72) Inventors: Jiasheng Cao, The Woodlands, TX (US); Daryl D. McCracken, Houston, TX (US); Evan Kent Dawson, Houston, TX (US)

(73) Assignee: Baker Hughes Incorporated, Houston, TX (US)

(21) Appl. No.: 13/972,545

(22) Filed: Aug. 21, 2013

(51) Int. Cl. C02F 9/00; C02F 1/28; C02F 1/463

(52) U.S. Cl. CPC C02F 9/00; C02F 1/463; C02F 1/281
USPC 210/667

(57) ABSTRACT

Both the hardness and boron content of wastewater may be reduced by contacting the wastewater with liquid sodium silicate (LSS) in an effective amount for such reductions followed by one or both of two additional procedures. The additional procedure may be contacting the wastewater with an Al(3+)-containing compound in an amount effective to at least partially remove silicon from the wastewater, where the contacting is before, during or after the wastewater is contacted with LSS. The second additional or alternative procedure involves, subsequent to contacting the wastewater with LSS, treating the untreated water with an electrocoagulation (EC) apparatus for a period of time effective to at least partially remove silicon from the wastewater. The EC procedure may also further remove boron from the wastewater.

### TECHNICAL FIELD

The present invention relates to methods and apparatus for reducing the hardness of and removing boron from wastewater, and more particularly relates to methods and apparatus for simultaneously reducing the hardness of and removing boron from wastewater, such as, but not limited to, ground water, irrigation industry water, refinery water, oilfield produced water, and flowback water from hydraulic fracturing fluids selected from the group consisting of slickwater fracturing fluids, linear polymer fracturing fluids, and crosslinked polymer fracturing fluids, and mixtures thereof.

### TECHNICAL BACKGROUND

Water is a valuable resource. Many oil and natural gas production operations generate, in addition to the desired hydrocarbon products, large quantities of waste water, referred to as “produced water”. Produced water is typically contaminated with significant concentrations of chemicals and substances requiring that it be disposed of or treated before it can be reused or discharged to the environment. Produced water includes natural contaminants that come from the subsurface environment, such as hydrocarbons from the oil- or gas-bearing strata and inorganic salts. Produced water may also include manmade contaminants, such as drilling mud, “frac flow back water” that includes spent fracturing fluids including polymers and inorganic cross-linking agents, polymer breaking agents, friction reduction chemicals, and artificial lubricants. These contaminants are injected into the wells as part of the drilling and production processes and recovered as contaminants in the produced water.

There are several commonly encountered non-natural contaminants in produced water; which contaminants and their sources are next discussed.
From high-viscosity fracturing operations—gellants in the form of polymers with hydroxyl groups, such as guar gum or modified guarbased polymers; cross-linking agents including borate-based crosslinkers; non-emulsifiers; and sulfate-based gel breakers in the form of oxidizing agents such as ammonium persulfate.
From drilling fluid treatments—acids and caustics such as soda ash, calcium carbonate, sodium hydroxide and magnesium hydroxide; bactericides; defoamers; emulsifiers; filtrate reducers; shale control inhibitors; deicers including methanol and thinners and dispersants.
From slickwater fracturing operations—viscosity reducing agents such as polymers of acrylamide.

It may be seen that there is a very wide range of contaminant species and that the quality of produced water from different sources can vary markedly. Much effort has been expended to create a cost effective treatment system that can treat or recycle the spectrum of possible produced water streams. For example, while reverse osmosis is effective in treating many of the expected contaminants in produced water, it is not very effective in removing methanol and it may be fouled by even trace amounts of acrylamide.

As another example, there have been many attempts to reclaim produced water and reuse it as fracturing feed water, commonly referred to as “frac water”. Frac water is a term that refers to water suitable for use in the creation of fracturing (frac) gels which are used in hydraulic fracturing operations. Frac gels are created by combining frac water with a polymer, such as guar gum, and in some applications a cross-linker, typically borate-based, to form a fluid that gels upon hydration of the polymer. Several chemical additives generally will be added to the frac gel to form a treatment fluid specifically designed for the anticipated wellbore, reservoir and operating conditions.

One problem occurs when the produced water is contaminated with boron, such as from the use of borate-based cross-linking agents, and it is desirable to discharge the water to the environment. One way to treat produced water containing boron is referred to as the HERO® process in which the pH is raised up to at least about 11 prior to treatment with reverse osmosis, resulting in the boron being rejected with the reverse osmosis reject brine. However, raising the pH has several undesirable attributes. First, there is increased scaling within the reverse osmosis system increasing the maintenance costs of the system. Second, the pH must then be reduced before the treated water may be discharged to the environment. Third, the cost of the chemicals to raise the pH coupled with the cost of immediately thereafter lowering the pH and the cost of disposal of the precipitated salts resulting from the lowering of the pH make the HERO® process very expensive.

However, it is not always necessary to remove all of the boron if the produced water is to be reused as frac water or for applications or purposes that do not require highly pure water. It may only be necessary to remove enough of the boron so that when the treated water is re-used as frac water that the level of boron present does not adversely interfere with the purposes of the frac water, for instance, premature crosslinking the polymer in the water before it is introduced downhole and placed adjacent the subterranean formation desired to be fractured.

Boron selective resin has been used commercially to remove boron from different water types, such as drinking water, ground water, waste water, irrigation water and industry water. The boron removal efficiency using these resins depends on the initial boron concentration; the lower the boron initial concentration, the higher the boron removal efficiency and capacity. However, when treating oil water to remove boron using a boron selective resin, oil and total suspended solids (TSS), or total dissolved solids (TDS), reduce the boron selective resin efficiency and capacity for boron removal.

Hard water is water that has a relatively high mineral content. Water hardness may cause potentially serious problems in industrial and efforts to efficiently produce hydrocarbons from a subterranean formation. Hard water can precipitate hard, off-white chalky deposits called scale, the main component of which is calcium carbonate. Scale buildup inside pipes, tubes, valves, heat exchangers and other equipment can reduce the liquid flow and even deposit to the extent that flow is completely blocked. Such partial and/or complete blockages can reduce the efficiencies of hydrocarbon recovery processes and in extreme cases can be dangerous in that pressure and/or heat can build up to explosive levels.

It would thus be very desirable to discover alternative methods and apparatus for reducing the level of boron in water, particularly quickly and easily reducing the level of boron in water while not necessarily removing all of the boron or purifying the water. It would be particularly advantageous if water hardness could be simultaneously reduced at the same time boron is removed or reduced from the water.

### SUMMARY

There is provided, in one non-limiting form, a method for simultaneously reducing hardness of and at least partially removing boron from wastewater, where the method involves contacting the wastewater with liquid sodium silicate (LSS) in an amount effective to reduce hardness and at least partially remove boron from the wastewater, and an additional procedure. The additional procedure may be (1) before, during or after contacting the wastewater with liquid sodium silicate LSS, contacting the wastewater with an Al(3+)-containing compound in an amount effective to at least partially remove silicon from the wastewater, and/or (2) subsequent to contacting the wastewater with LSS, treating the untreated water with an electrocoagulation apparatus for a period of time effective to at least partially remove silicon from the wastewater. The method gives a treated effluent.

### BRIEF DESCRIPTION OF THE DRAWINGS

The following Figure is part of the present specification, included to demonstrate certain aspects of various embodiments of this disclosure and referenced in the detailed description herein:

FIG. 1 is a schematic diagram of an exemplary treatment process which demonstrates contacting waste water with liquid sodium silicate (LSS) and an Al(3+)-containing compound in accordance the present disclosure; and

FIG. 2 is a schematic diagram of an alternative exemplary treatment process which demonstrates contacting waste water with liquid sodium silicate (LSS) and an electrocoagulation system, optionally also with an Al(3+)-containing compound in accordance the present disclosure.

It will be appreciated that the Figures are schematic illustrations which are not necessarily to scale and that certain features are exaggerated for clarity, and thus the methods and apparatus described herein should not be limited by the drawings.

### DETAILED DESCRIPTION

It has been discovered that the hardness and boron content of wastewater containing both may be reduced by contacting the wastewater with liquid sodium silicate (LSS) and one or both of an additional procedure, which additional procedure may be contacting the wastewater with an Al(3+)-containing compound in an amount effective to at least partially remove silicon from the wastewater and/or treating the untreated water with an electrocoagulation apparatus for a period of time effective to at least partially remove silicon from the wastewater.

Characteristics and advantages of the present disclosure and additional features and benefits will be readily apparent to those skilled in the art upon consideration of the following detailed description of exemplary embodiments of the present disclosure and referring to the accompanying Figure. It should be understood that the description herein and appended drawings, being of example embodiments, are not intended to limit the claims of this patent application, any patent granted hereon or any patent or patent application claiming priority hereto. On the contrary, the intention is to cover all modifications, equivalents and alternatives falling within the spirit and scope of the claims. Many changes may be made to the particular embodiments and details disclosed herein without departing from such scope.

In showing and describing preferred embodiments, common or similar elements are referenced in the appended Figure with like or identical reference numerals or are apparent from the Figure and/or the description herein.

As used herein and throughout various portions (and headings) of this patent application, the terms “invention”, “present invention” and variations thereof are not intended to mean every possible embodiment encompassed by this disclosure or any particular claim(s). Thus, the subject matter of each such reference should not be considered as necessary for, or part of, every embodiment hereof or of any particular claim(s) merely because of such reference. The terms “coupled”, “connected”, “engaged”, “carried” and the like, and variations thereof, as used herein and in the appended claims are intended to mean either an indirect or direct connection or relationship, unless otherwise specified. For example, if a first device or step or procedure couples to a second device or step or procedure, that connection may be through a direct connection, or through an indirect connection via other devices and connections.

Certain terms are used herein and in the appended claims to refer to particular components. As one skilled in the art will appreciate, different persons may refer to a component by different names. This document does not intend to distinguish between components that differ in name but not function. Also, the terms “including” and “comprising” are used herein and in the appended claims in an open-ended fashion, and thus should be interpreted to mean “including, but not limited to . . . ”. Further, reference herein and in the appended claims to components and aspects in a singular tense does not necessarily limit the present disclosure or appended claims to only one such component or aspect, but should be interpreted generally to mean one or more, as may be suitable and desirable in each particular instance.

Sodium silicate is the common name for the compound sodium metasilicate, Na₂SiO₃, also known as waterglass or liquid glass. Sodium silicate is available in aqueous solution and in solid form, and has a number of industrial uses, including, but not necessarily limited to use in cements, as passive fire protection, as refractories, and the like, etc. Liquid sodium silicate (LSS) is often used with sea water to prepare cementing for drilling. The method here uses the liquid, aqueous solution form. In one suitable format, the LSS is 38.3 wt % Na₂SiO₃.

The amount of LSS used to contact the wastewater may be up to about 10% (volume/volume) of the wastewater volume, in one non-limiting embodiment, alternative up to about 2% (v/v) of the wastewater. Suitable lower limits may include, but not necessarily be limited to about 0.2% v/v or alternatively about 0.5% v/v.

It is emphasized that the initial wastewater being treated in one non-limiting embodiment may be raw or untreated water, including but not necessarily limited to, ground water, irrigation industry water, refinery water, oilfield produced water, and flowback water from hydraulic fracturing fluids selected from the group consisting of slickwater fracturing fluids, linear polymer fracturing fluids, and crosslinked polymer fracturing fluids, and mixtures thereof.

While the contacting of the wastewater with LSS may remove boron and reduce hardness, the treatment adds silicate ions in solution. An increase in silicate ions may cause a problem for water quality. Thus, it may be desirable or necessary to further treat the wastewater by contacting with Al(3+) ions and/or treatment with electrocoagulation.

Suitable Al(3+)-containing compounds for contacting the wastewater may include, but not necessarily be limited to, AlCl₃, Al₂(SO₄)₃, Al(OH)₃, Al(NO₃)₃, KAl(SO₄)₂, polyaluminum chloride of the formula [Al₂(OH)ₙCl₆₋ₙ. xH₂O]ₘ where m is equal or less than 10 and n ranges from 1 to 5 and x ranges from 0 to 8, NaAlO₂, and combinations thereof. In one non-limiting embodiment, the effective amount of the Al(3+)-containing compound ranges up to about 1500 mg/L, based on the amount of LSS; alternatively up to about 1200 mg/L of Al(3+) ions; and in another suitable amount, up to about 500 mg/L of Al(3+) ions. Lower proportion ranges may independently be about 1 mg/L, alternatively 10 mg/L and 20 mg/L. When the word “independently” is used herein with respect to a range, it is intended that any lower threshold may be used together with any upper threshold to create a valid, suitable alternative range.

Goals of the method and apparatus described herein include, but are not necessarily limited to reducing the concentration of oil, boron, iron ions and hardness. However, hardness may be defined as a measure of the calcium, magnesium and strontium irons in the water, that is, alkaline earth metal ions, and alternatively as a measure of the calcium carbonate (CaCO₃) present. In a non-restrictive instance, the untreated water may be surface water with high concentration of boron, fresh or brackish ground water with high boron levels, any produced water including but not limited to flow back water from slickwater, linear, crosslinked frac fluid systems, and the like.

In one non-limiting embodiment, the untreated water may have a composition falling within the parameters of Table I, whereas non-restrictive ranges of the resulting boron and hardness after treatment are also shown in this Table.

TABLE I
Permissible Untreated Water Composition

| Component | Initial Proportion | Final Proportion |
|---|---|---|
| Boron | Greater than | Less than |
| | about 200 mg/L | about 50 mg/L |
| Iron | About 0-125 mg/L | Less than |
| | | about 10 mg/L |
| Hardness taken as calcium | Greater than | Less than |
| carbonate (CaCO₃) | 45,000 mg/L | about 40,000 mg/L |
| TDS | 10,000-250,000 mg/L | No requirement |

It is not necessary that all of the contaminants addressed be completely removed from the water for the method and apparatus herein to be considered successful. For instance, it may only be necessary to reduce enough of the contaminant so that it does not adversely interfere with the next use of the water. In the case of boron, if the reduced-boron content water has the boron concentration reduced to a sufficient extent that it does not interfere with the use of the water as frac water, for instance that it does not prematurely crosslink the polymer in the water to a problematic extent, this may be sufficient. In one non-limiting embodiment the resulting reduced-boron content water may contain less than about 50 mg/L boron, in one embodiment less than about 30 mg/L boron, and alternatively less than about 10 mg/L boron. A non-limiting goal may be to reduce boron levels sufficient to reuse the water in other oilfield applications. Of course, it is acceptable if all, or essentially all, of the contaminants are removed, for instance if all of the boron is removed. The initial untreated water may contain more than about 100 mg/L boron.

For hardness, the total hardness as calcium carbonate may be over 3000 mg/L, and alternatively as noted in Table I over about 45,000 mg/L. In one non-limiting embodiment the hardness for water treated as described herein may be below about 40,000 mg/L (as noted in Table I) or alternatively below about 1000 mg/L.

Electrocoagulation removes suspended solids and oil from oil produced water, flowback water, and slick water. It has also been discovered that electrocoagulation lowers boron concentration from water and removes silicate ions. It has been further surprisingly found that electrocoagulation could treat untreated or raw water, such as an oil water sample to remove oil, suspended solids, and lower boron concentration, to increase boron removal efficiency with LSS in a subsequent treatment step or procedure.

In more detail, electrocoagulation was discovered to be useful to treat oil water sample containing boron, oil, silicate and other ions. However, it should be understood that while electrocoagulation may remove some boron, silicate and other ions, it is not necessary that the electrocoagulation remove any particular other ions for the method and apparatus described herein to be successful.

With respect to the electrocoagulation apparatus, the apparatus may have electrodes that are non-consumable, and in a specific case, the non-consumable electrodes comprise ruthenium-coated titanium. “Non-consumable” as used herein means that the mass of the electrode is not significantly diminished or consumed during the electrocoagulation process. As will be discussed in more detail below, the electrocoagulation apparatus may comprise sacrificial aluminum in various forms, including, but not necessarily limited to, reclaimed aluminum cans. Further, the electrocoagulation apparatus may treat the untreated water with a voltage between the electrodes of up to 200 volts and a current between the electrodes of up to 1000 amps. Alternatively, the voltage may range from about 20 independently to about 30 volts, and the amperage may range from about 500 independently up to about 800 amps.

The method from the introduction of the untreated water into the process to the end result of giving reduced-boron content water is relatively very short. This is defined herein as the residence time. For the process embodiment comprising using both LSS and Al(+3) ions, the total residence time may be 60 minutes or less, alternatively 25 minutes or less. For the embodiment where contacting with LSS is followed by electrocoagulation the total residence time may be 60 minutes or less, alternatively 30 minutes or less. These times are in contrast to more involved and complex methods and apparatus which may have a residence time of many hours to many days, but which may possibly produce purer water.

In another non-limiting embodiment, after the water is treated by the electrocoagulation (EC) apparatus, the method includes settling the effluent for a period of time between about 10 independently to about 60 minutes, alternatively from about 30 independently to about 40 minutes and drawing off a top layer for re-use, recycling or further treatment.

In another non-restrictive version, the flow rate ranges may range from about 100 gallons/minute independently to about 300 gallons/minute.

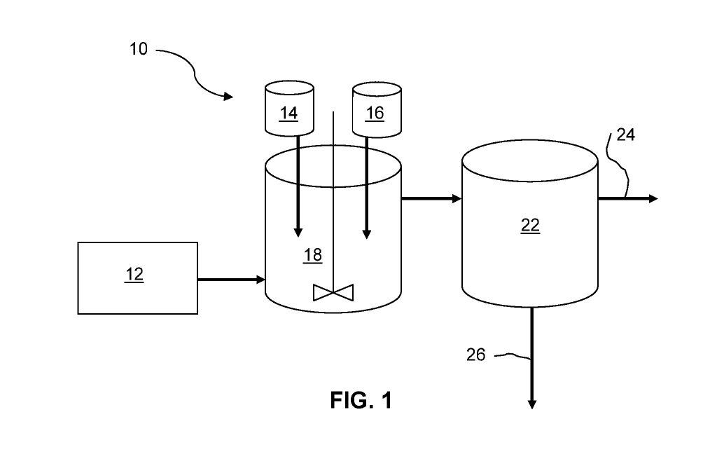

Even more specifically with respect to the method herein and referring to FIG. 1, in one non-limiting embodiment of the method described herein, the general treatment method 10 is schematically illustrated where wastewater source 12 feeds into a mixing tank 18. Al(3+) ions are fed from Al(3+) source 14 and LSS is fed from LSS source 16 simultaneously or sequentially into mixing tank 18. The effluent from mixing tank 18 is fed to filtration/separation stage 22, where the treated effluent 24 having reduced hardness and boron content is drawn off and re-used or recycled, in a non-limiting instance for a fracking fluid. Generated sludge 26 may be reclaimed for use in cementing materials and the like.

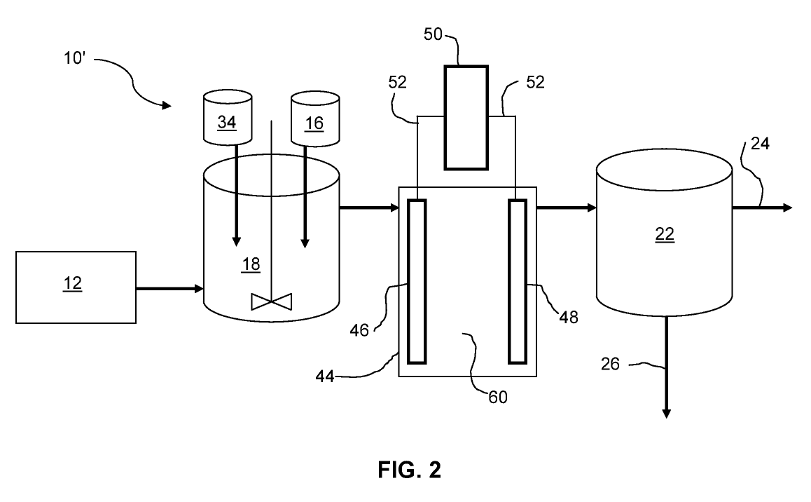

In an alternative non-limiting embodiment of the method described herein referring to FIG. 2, the general treatment method 10′ is schematically illustrated where wastewater source 12 feeds into a mixing tank 18. LSS is fed from LSS source 16 as before. Al(3+) ions are optionally fed from Al(3+) source 34. That is, in one non-restrictive version, nothing is introduced from source 34. The effluent from mixing tank 18 is delivered to second container 44. A first electrode 46 and a second electrode 48 can be disposed in the effluent composition in the electrocoagulation (EC) stage or second container 44. The first and second electrodes (46, 48, respectively) can be electrically connected by wires 52 with a power source 50 there between.

The power source 50 is configured to apply a voltage difference to the first and second electrodes (46, 48, respectively) that causes an electrochemical reaction to occur at the first and second electrodes (46, 48, respectively). In one non-limiting embodiment, the first electrode 46 is an anode that includes an anode material and which oxidizes in response to the applied voltage from the power source 52 such that ions of the anode material are released from the first electrode 46 into the composition. In this regard, the second electrode 48 is a cathode that includes a cathode material. The cathode material can cause the reduction of a component (e.g., a solute, solvent, molecular, atom, particle, and the like) in the composition by donation of an electron to the component upon application of the voltage from the power source 50 to the second electrode. In another non-restrictive version, the polarity of the voltage delivered to the first electrode 46 and the second electrode 48 can be swapped such that the first electrode 46 is a cathode and the second electrode 48 is an anode. Swapping the polarity can occur, e.g., by switching the wires 52 at the power source or at the first and second electrodes (46, 48) by using a switching system between the power source 50 and the first and second electrodes (46, 48) or by using a power source 50 that is configured to switch a polarity among its output, and the like.

In another non-limiting embodiment, the second container 44 itself can be a counter electrode to the first electrode 46 so that a second electrode 48 need not be present. Here, the second container 44 can be grounded or can be isolated from ground and biased by, e.g., the power source 50. In another non-restrictive version, the second container 44 can include a surface that can have a potential applied to it from a power source 50 so that the surface is a counter electrode to the first electrode 46, and the second electrode 48 can or cannot be present.

Without wishing to be bound by any one theory, electrocoagulation produces a precipitate from the ions of the anode material and components of the composition or mixture within gap 60 between electrodes 46 and 48. In one non-limiting embodiment, a component of the treated wastewater and the ions of the anode material forms the precipitate. According to one embodiment, the precipitate includes a reaction product of the composition and ions from the anode material.

It should be understood that the above-referenced components and features may have any other suitable form, construction, configuration and operation as is or becomes further known. Further, additional or different components may be included. Moreover, the above-referenced components are not limiting upon or required for the present disclosure, the appended claims or the claims of any patent application or patent claiming priority hereto, except and only to the extent that they are expressly required in a particular claim. Accordingly, the subject matter of the present disclosure, one or more embodiments of which will be described below, may be used in connection with a boron removal and hardness reduction method using a treatment system 10 or 10′ that does or does not include all of the above-described components, features or capabilities, and may have additional or different components. For instance, the treatment system 10 or 10′ may be configured to not include Al(3+) source 14 or not include electrocoagulation stage 44.

In accordance with an embodiment of the present disclosure where electrocoagulation stage 44 is used, at least one sacrificial material (not shown) may be disposed near or between the electrodes but not directly connected to a power source (not shown). The sacrificial metallic material is material that will be exposed to the contaminated liquid as it passes through the gap or spaces between electrodes and which dissolves during, or provides sacrificial metal ions necessary for, electrocoagulation treatment of the liquid. A few examples of sacrificial metallic material which may be used include iron and aluminum. However, other suitable metallic materials, or combinations of materials, may be used.

It should be noted that, while a single pair of electrodes and a single corresponding module of sacrificial material may be used, multiple pairs of electrodes and corresponding sacrificial material modules may be included. Further, more than one module may be disposed between a single pair of electrode. If desired, multiple sets of electrodes and sacrificial modules may be included in the same or multiple reaction chambers of electrocoagulation stage 44. Further, multiple sacrificial modules may be included between a single set of electrodes. The sacrificial materials may have any kind of suitable shape, including, but not necessarily limited to, coil springs, disc springs, corrugated metal sheets, accordion-like configurations, helixes, twists, shreds, metal shavings, beads, pellets, spheres, and even recycled aluminum cans and pieces thereof.

In a preferred embodiment, the electrodes may be non-sacrificial, non-consumable or configured not to dissolve or provide sacrificial metal ions during electrocoagulation treatment. For example, the electrodes may be passivated or constructed of or coated with one or more noble metal material, such as ruthenium, or include one or more oxidation-resistant and corrosionresistant material, such as diamond or graphite. Consequently, in use of this embodiment during electrocoagulation treatment of liquid in the reaction stage, the sacrificial metallic material of the module will preferably dissolve, preserving the integrity of the electrodes. In such instances, it may not be necessary to remove and clean or replace the electrodes. However, this feature is not required and, in other embodiments, the electrodes may also include sacrificial metallic material.

In another independent aspect of the present disclosure, methods for simultaneously reducing hardness and at least partially removing boron may be used in connection with hydrocarbon exploration and production operations in the treatment of waste fluids produced or recovered during hydrocarbon drilling, production or related operations (e.g. transportation, storage, etc.). These waste fluids may arise, for example, during well stimulation, acid flow back, initial well flow back, completions, acid mine drainage, pipeline maintenance or at another time during operations. These waste fluids, also referred to as produced water, production fluid and waste water, are referred to herein and in the appended claims as “produced water”. In some instances, after treatment of produced water with the general treatment system 10, the resulting water can be reused in other oilfield operations.

The invention will now be described with respect to particular embodiments of the invention which are not intended to limit the invention in any way, but which are simply to further highlight or illustrate the invention.

### Examples 1-3

### Boron Removal and Hardness Reduction Using LSS and Al(3+)

Al(3+) containing compounds (such as AlCl₃) and liquid sodium silicate (LSS, 38.2% of Na₂SiO₃) were added into wastewater samples in varied amounts and mixed. The samples were settled and then filtered through 25 μm filter paper, which served as the filtration/separate stage 22 as in FIG. 1. Raw water and treated water were analyzed with Inductive Coupling Plasma (ICP). The waste water contains calcium (Ca), magnesium (Mg), strontium (Sr), boron (B), silicon (Si) and other contaminants. Adding silicate into water increases solution pH and forms magnesium hydroxide (Mg(OH)₂), calcium hydroxide (Ca(OH)₂) and strontium hydroxide (Sr(OH)₂), and alumina hydroxide (Al(OH)₃) precipitates. Silicate reacts with metal ions (such as Ca²⁺, Mg²⁺, Sr2+) and forms precipitates of CaSiO₃, MgSiO₃. Alumina (Al³⁺), silicate and other metal ions (such as Ca²⁺, Mg²⁺, Sr²⁺) could form alumina silicate precipitates. Boron removal was achieved by sorption to those precipitates.

Three different water samples were tested by adding Al-containing compound and liquid sodium silicate. The water samples had varied concentration of boron and hardness. The total hardness as CaCO₃ was calculated with the concentration of Ca, Mg and Sr.

### Example 1

Water sample 1 was synthetic water with Ca, Mg, Sr and B as further specified in Table II. The adding of 660 mg/L of SiO₃²⁻ and 288 mg/L of Al³⁺ reduced 80.1% of total hardness and 60.7% of boron. Solution pH increased from 7.9 to 9.48. Adding more Al³⁺ lowered pH due of forming of Al(OH)₃ precipitate, did not increase total hardness removal, but increased boron removal.

TABLE II
Chemistry of Water Sample 1 Before and After Treatment

| | | Treatment (Chemical Total Amount) | | |
|---|---|---|---|---|
| | | SiO₃²⁻ (600 | SiO₃²⁻ (600 | SiO₃²⁻ (600 |
| Ion | | mg/L) + Al³⁺ | mg/L) + Al³⁺ | mg/L) + Al³⁺ |
| (mg/L) | Raw | (240 mg/L) | (568 mg/L) | (1280 mg/L) |
| Al | 0.23 | 0.031 | 0.329 | 0.012 |
| B | 93.0 | 36.5 | 31.5 | 22.05 |
| Ca | 515 | 155 | 165 | 145 |
| Mg | 373 | 18.3 | 34.8 | 39.98 |
| Sr | 207.5 | 126 | 137.28 | 101.75 |
| Total | 3087.2 | 612.8 | 694.7 | 650 |
| hardness (as | | | | |
| CaCO3) | | | | |
| Hardness | — | 80.1% | 77.5% | 78.94% |
| removal | | | | |
| Si | 10.65 | 80 | 55.7 | 36.47 |
| pH | 7.9 | 9.48 | 9.06 | 8.51 |

### Example 2

Water sample 2 was synthetic water with Ca, Mg, Sr and B as further specified in Table III.

TABLE III
Chemistry of Water Sample 2 Before and After Treatment

| | | Treatment (chemical total amount) | | |
|---|---|---|---|---|
| | | SiO₃²⁻ (450 | SiO₃²⁻ (450 | SiO₃²⁻ (450 |
| Ion | | mg/L) + Al³⁺ | mg/L) + Al³⁺ | mg/L) + Al³⁺ |
| (mg/L) | Raw | (230 mg/L) | (460 mg/L) | (1280 mg/L) |
| Al | 0.265 | 0.253 | 0.226 | 0.04 |
| B | 149 | 67 | 60.6 | 37.85 |
| Ca | 546 | 179 | 188 | 188 |
| Mg | 204 | 11.4 | 18.2 | 29.8 |
| Sr | 216 | 135 | 129 | 115 |
| Total | 2470.62 | 654.76 | 698.49 | 730.26 |
| hardness | | | | |
| Hardness | — | 73.49% | 71.73% | 70.44% |
| removal | | | | |
| Si | 11.9 | 88.1 | 61 | 22.45 |
| pH | 7.64 | 9.51 | 9.21 | 8.1 |

### Example 3

Water sample 3 was field water with high concentrations of Ca, Mg, Sr and B as shown in Table IV. By adding 1500 mg/L SiO₃²⁻ and 1500 mg/L Al³⁺, boron was lowered from 203 to 84.7 mg/L, representing 58.3% removal.

TABLE IV
Chemistry of Water Sample 3 Before and After Treatment

| | | Treatment (chemical total amount) | |
|---|---|---|---|
| Ion | | SiO₃²⁻ (900 mg/L) + | SiO₃²⁻ (1500 mg/L) + |
| (mg/L) | Raw | Al³⁺ (580 mg/L) | Al³⁺ (1500 mg/L) |
| Al | 0.961 | 0.366 | 0.03 |
| B | 203 | 135 | 84.7 |
| Ca | 16880 | 15500 | 14100 |
| Mg | 1048 | 890 | 693 |
| Sr | 1208 | 1160 | 1090 |
| Total | 47996.25 | 43831.11 | 39427.44 |
| Hardness | | | |
| (as CaCO₃) | | | |
| Hardness | — | 8.68% | 17.85% |
| removal | | | |
| Si | 10.08 | 0.32 | 0.5 |
| pH | 4.61 | 8.44 | 8.31 |

It may thus be seen that the combination of treatment of wastewater with LSS and Al(3+) consistently and effectively reduces hardness and boron content while minimizing additional silicon presence.

### Examples 4-8

### Boron Removal and Hardness Reduction using LSS and EC

In the method described herein, liquid sodium silicate (38.2% of Na₂SiO₃) was first added into wastewater sample at various volume ratio and mixed for 5 minutes. The sample was then filtered through 25 μm filter paper (as in filtration/separation stage 22 of treatment method 10 in FIG. 1 and analyzed with ICP. The waste water contains calcium (Ca), magnesium (Mg), strontium (Sr), boron (B) and silicon (Si).

### Examples 4-5

### Silicate for Hardness and Boron Removal

Table V shows the concentration change of B, Ca, Mg, Sr and Si after adding liquid sodium silicate. The results indicated that adding higher volume of liquid sodium silicate removed more Ca, Mg, and Sr, but added more Si into solution. Hardness removal of 82.4% and 92.8% was achieved with adding 2% of liquid sodium silicate from water samples 4 and 5, respectively. Sodium silicate reacts with water and produces hydroxide ion (OW) and increases solution pH. By reacting with ions of Ca, Mg and Sr, silicate forms precipitates as form of CaSiO₃, MgSiO₃, and SrSiO₃.

In contrast to hardness removal with high amounts of silicate, increasing the silicate amount did not result in higher boron removal at certain boron concentrations. In this testing, the maximum boron removal for water sample 4 was from 93.0 mg/L to about 45 mg/L, and for water sample 5 was from 62.3 to 39 mg/L, representing maximum 51% and 37.4% boron removal, respectively, even with 2% (v/v) of liquid sodium silicate addition. It is believed that the boron removal was mainly from the sorption of boron onto formed MgSiO₃ precipitate. Boron and silica are believed to bind to specific adsorption sites through ligand exchange with hydroxyl group.

TABLE V
Water Chemistry Before and After Adding Liquid Sodium Silicate

| | Water sample 1 | | | | Water Sample 2 | | | |
|---|---|---|---|---|---|---|---|---|
| | | +SiO₃ | +SiO₃ | +SiO₃ | | +SiO₃ | | |
| Ion | | 1% | 1.5% | 2% | | 0.5%(v/ | +SiO₃ | +SiO₃ |
| (mg/L) | Raw | (v/v) | (v/v) | (v/v) | Raw | v) | 1% (v/v) | (2% v/v) |
| B | 93.0 | 53.0 | 45.1 | 46.0 | 62.3 | 48.2 | 38.9 | 39.6 |
| Ca | 515 | 353.5 | 225.5 | 133 | 490 | 400 | 262 | 33.3 |
| Mg | 373 | 132.5 | 47.75 | 14.2 | 185 | 99.5 | 26.7 | 0.686 |
| Sr | 207.5 | 182 | 157 | 128 | 195 | 191 | 166 | 63.3 |
| Total | 3087.2 | 1651.2 | 948.5 | 543.1 | 2226.6 | 1640.6 | 962.7 | 161.0 |
| hardness | | | | | | | | |
| (as | | | | | | | | |
| CaCO₃) | | | | | | | | |
| Hardness | — | 46.5% | 69.3% | 82.4% | — | 26.3% | 56.8% | 92.8% |
| removal | | | | | | | | |
| Si | 10.65 | 56.5 | 60.5 | 107 | 10.1 | 94.6 | 75.2 | 320 |

### Examples 6-7

### Electrocoagulation for Si Removal

The electrocoagulation (EC) system used in this method contained two non-reactive electrodes and sacrificial Al materials. The EC system has shown successful removal of Si from waste water or industry water. Table VI shows industry water treatment with EC. Both water samples 6 and 7 had around 66 mg/L boron in the raw water, and over 97% removal was achieved with EC treatment of the two water samples.

Boron removal with EC in Table VI was not significant. The EC treated water has 41.8 and 46.7 mg/L boron, respectively, while the initial concentration was 56 mg/L for both water samples, representing 25% and 16.8% removal.

Boron removal with EC system has been previously reported, and the removal efficiency was influenced by treatment parameters such as solution pH, initial boron concentration, the amount of coagulant and temperature. It has been found that it is a challenge to achieve low concentration boron removal using only an EC system.

TABLE VI
Water Chemistry Before and After EC Treatment

| | | |
|---|---|---|
| Item | Water sample 3 | Water sample 4 |

| (mg/L) | Raw | EC treated | Raw | EC treated |
|---|---|---|---|---|
| B | 56.2 | 41.8 | 56.1 | 46.7 |
| Ca | 149 | 52 | 0.16 | 1.49 |
| Mg | 55 | 19.5 | 0.04 | 0.98 |
| Sr | 5.11 | 1.4 | 0 | 0.02 |
| Si | 66.9 | 1.42 | 66.3 | 0.81 |

### Example 8

### Process Combining Sodium Silicate and Electrocoagulation

The process described herein of combining adding liquid sodium silicate and performing the EC treatment was applied for treatment of water sample 4. As present in Table VII, EC following contact with liquid sodium silicate further removed Ca, Mg and Sr ions, and also reduced the Si ion concentration. After treatment with an EC apparatus, further total hardness reduction was observed, but no significant B removal was obtained. More important, the final Si in solution was lowered.

TABLE VII
Water Chemistry of Water Sample 4 in Each Step of the Process

| | | +SiO₃ | +SiO₃ | +SiO₃ | SiO₃ |
|---|---|---|---|---|---|
| Item | Water 4 | 1% | (1%) + | 1.5% | (1.5%) + |
| (mg/L) | Raw | (v/v) | EC | (v/v) | EC |
| B | 93 | 53 | 52.5 | 45.1 | 43.2 |
| Ca | 515 | 353.5 | 314 | 225.5 | 219.5 |
| Mg | 373 | 132.5 | 108 | 47.75 | 42.75 |
| Sr | 207.5 | 182 | 133.5 | 157 | 106.5 |
| Total | 3087.2 | 1651.2 | 1392.9 | 948.5 | 852.9 |
| hardness | | | | | |
| (as CaCO₃) | | | | | |
| Hardness | — | 46.5% | 54.9% | 69.3% | 72.4% |
| removal | | | | | |
| Si | 10.65 | 56.5 | 21.7 | 60.5 | 10.95 |

In one non-limiting embodiment, the method and apparatus herein independently have an absence of a reverse osmosis system, an absence of an API separator, an absence of an anaerobic treatment stage, an absence of an aeration stage, an absence of a dissolved-air flotation (DAF) system, an absence of a sand filter, an absence of a bioreactor, and an absence of a membrane bioreactor, and further do not use consumable electrodes as in U.S. Pat. No. 8,105,488. Unlike the method and apparatus described herein, the '488 method and apparatus treats waters having methanol. The '488 method and apparatus also treats water having relatively low hardness, whereas the present method and apparatus may treat water having relatively high hardness, that is having greater than 1000 mg/L hardness, even greater than 45,000 mg/L. The residence times for the '488 method and apparatus is measured in days, such as 50 days or more, as contrasted with the residence time in the present method is measured instead in minutes, for instance 60 minutes or less.

U.S. Pat. No. 4,049,545 involves a method of treating domestic, commercial or industrial waste water which includes the steps of mixing the waste water with a coagulant aid so as to bring the pH of the mixture to within a range of about 9.0-10.5, and thereafter adding precipitating agents in at least two successive steps so as to lower the pH of the mixture by about one unit for each step and thereby precipitate solids therefrom until the mixture is approximately neutral. After the addition of each precipitating agent, the precipitated solids are separated from the waste water effluent before the next succeeding precipitating agent is added. Preferably in this patented method two such successive precipitation steps are performed, after which the resultant waste water effluent is treated with an oxidizing and disinfecting agent, filtered, and then treated with a further oxidizing and disinfecting agent to minimize the B.O.D. (biochemical oxygen demand) level. In the course of the process, a portion of the solids separated from the waste water effluent in the respective steps is preferably recycled into the treatment system by mixing it with new incoming waste water to partially take the place of the original coagulant aid. The preferred coagulant aid utilized is Portland cement, with aluminum sulfate and copper sulfate preferably being used in sequence as the precipitating agents and potassium permanganate and ozone being used in sequence as the oxidizing and disinfecting agents. It will be appreciated that the '545 patent method and apparatus uses solid Portland cement as a possible and preferred coagulant aid to increase the water pH to 9-10.5 whereas the sodium silicate in the present method is a liquid. The '545 patent method teaches aluminum sulfate as a first precipitating agent to remove heavy solids in contrast to the present method which uses aluminum compounds to lower the silicon concentration. The '545 patent method discloses copper sulfate as a second precipitating agent to remove heavy solids; the present method optionally has an absence of copper sulfate. The '545 patent method discloses oxidizing agents and disinfecting agents; the present method optionally has an absence of oxidizing agents, and an independent absence of disinfecting agents.

It is to be understood that the invention is not limited to the exact details of composition, procedure, construction, operation, exact materials, or embodiments shown and described, as modifications and equivalents will be apparent to one skilled in the art. Accordingly, the invention is therefore to be limited only by the scope of the appended claims. Further, the specification is to be regarded in an illustrative rather than a restrictive sense. For example, specific combinations of LSS contacting, Al(3+) contacting, electrocoagulation apparatus treatment, electrodes and sacrificial materials used therein, untreated waters, treatment conditions, and the like, falling within the claimed parameters, but not specifically identified or tried in a particular method or apparatus, are anticipated to be within the scope of this invention.

The terms “comprises” and “comprising” in the claims should be interpreted to mean including, but not limited to, the recited elements.

The present invention may suitably comprise, consist or consist essentially of the elements disclosed and may be practiced in the absence of an element not disclosed. For instance, there may be provided a method for simultaneously the reducing hardness of and at least partially removing boron from wastewater, where the method consists essentially of or consists of contacting the wastewater with liquid sodium silicate (LSS) in an amount effective to reduce hardness and at least partially remove boron from the wastewater; and the method further consists essentially of or consists of an additional procedure selected from the group consisting of (1) before, during or after contacting the wastewater with liquid sodium silicate LSS, contacting the wastewater with an Al(3+)-containing compound in an amount effective to at least partially remove silicon from the wastewater, and/or (2) subsequent to contacting the wastewater with LSS, treating the untreated water with an electrocoagulation apparatus for a period of time effective to at least partially remove silicon from the wastewater; where the method gives a treated effluent.

What is claimed is:

1. A method for simultaneously reducing hardness of and at least partially removing boron from wastewater, the method comprising:
contacting the wastewater with liquid sodium silicate (LSS) in an amount effective to reduce hardness and at least partially remove boron from the wastewater;
an additional procedure selected from the group consisting of:
before, during or after contacting the wastewater with liquid sodium silicate LSS, contacting the wastewater with an Al(3+)-containing compound in an amount effective to at least partially remove silicon from the wastewater,
subsequent to contacting the wastewater with LSS, treating the untreated water with an electrocoagulation apparatus for a period of time effective to at least partially remove silicon from the wastewater;
and combinations thereof; and
giving a treated effluent.

2. The method of claim 1 where the untreated water contains more than about 200 mg/L boron and the treated effluent contains less than about 50 mg/L boron.

3. The method of claim 1 where the hardness of the wastewater taken as calcium carbonate (CaCO₃) is over 45,000 mg/L and the hardness of the treated effluent taken as CaCO₃ is below 40,000 mg/L.

4. The method of claim 1 where the wastewater is selected from the group consisting of ground water, irrigation industry water, refinery water, oilfield produced water, and flowback water from hydraulic fracturing fluids selected from the group consisting of slickwater fracturing fluids, linear polymer fracturing fluids, and crosslinked polymer fracturing fluids, and mixtures thereof.

5. The method of claim 1 where the effective amount of LSS ranges up to about 10% (v/v) of the wastewater volume.

6. The method of claim 5 where the effective amount of the Al(3+)-containing compound ranges up to about 1500 mg/L, based on the amount of LSS.

7. The method of claim 1 where the Al(3+)-containing compound is selected from the group consisting of AlCl₃, Al₂(SO₄)₃, Al(OH)₃, Al(NO₃)₃, KAI(SO₄)₂, polyaluminum chloride of the formula [Al₂(OH)ₙCl₆₋ₙ.xH₂O]ₘ [Al(OH)₃], where m is equal or less than 10 and n ranges from 1 to 5 and x ranges from 0 to 8, NaAlO₂, and combinations thereof.

8. The method of claim 1 where in treating the untreated water with an electrocoagulation apparatus, the electrocoagulation apparatus comprises electrodes that are non-consumable.

9. The method of claim 8 where the non-consumable electrodes comprise ruthenium-coated titanium.

10. The method of claim 8 where the electrocoagulation apparatus comprises sacrificial aluminum.

11. The method of claim 1 where the method has a total residence time of 60 minutes or less.

12. The method of claim 1 where the electrocoagulation apparatus comprises at least one first electrode and at least one second electrode, and where the method comprises treating the wastewater with an electrocoagulation apparatus with a voltage between the electrodes of up to 200 volts and a current between the electrodes of up to 1000 amps.

13. The method of claim 1 where the method comprises both contacting the wastewater with an Al(3+)-containing compound and treating the wastewater with an electrocoagulation apparatus.

14. A method for simultaneously reducing hardness of and at least partially removing boron from wastewater, the method comprising:
contacting the wastewater with liquid sodium silicate (LSS) in an amount up to about 10% (v/v) of the wastewater volume to reduce hardness and at least partially remove boron from the wastewater;
an additional procedure selected from the group consisting of:
before, during or after contacting the wastewater with LSS, contacting the wastewater with an Al(3+)-containing compound in an amount effective to at least partially remove silicon from the wastewater, where the Al(3+) containing compound is selected from the group consisting of AlCl₃, Al₂(SO₄)₃, Al(OH)₃, Al(NO₃)₃, KAl(SO₄)₂, polyaluminum chloride of the formula [Al₂(OH)ₙCl₆₋ₙ.xH₂O]ₘ where m is equal or less than 10 and n ranges from 1 to 5 and x ranges from 0 to 8, NaAlO₂, and combinations thereof, and
subsequent to contacting the wastewater with liquid sodium silicate LSS, treating the untreated water with an electrocoagulation apparatus for a period of time effective to at least partially remove silicon from the wastewater;
and combinations thereof; and
giving a treated effluent.

15. The method of claim 14 where the untreated water contains more than about 200 mg/L boron and the treated effluent contains less than about 50 mg/L boron.

16. The method of claim 14 where the hardness of the wastewater taken as calcium carbonate (CaCO₃) is over 45,000 mg/L and the hardness of the treated effluent taken as CaCO₃ is below 40,000 mg/L.

17. The method of claim 14 where the wastewater is selected from the group consisting of ground water, irrigation industry water, refinery water, oilfield produced water, and flowback water from hydraulic fracturing fluids selected from the group consisting of slickwater fracturing fluids, linear polymer fracturing fluids, and crosslinked polymer fracturing fluids, and mixtures thereof.

18. The method of claim 14 where the effective amount of the Al(3+) containing compound ranges up to about 1500 mg/L, based on the amount of LSS.

19. A method for simultaneously reducing hardness of and at least partially removing boron from wastewater, the method comprising:
contacting the wastewater with liquid sodium silicate (LSS) in an amount effective to reduce hardness and at least partially remove boron from the wastewater;
an additional procedure selected from the group consisting of:
before, during or after contacting the wastewater with LSS, contacting the wastewater with an Al(3+)-containing compound in an amount effective to at least partially remove silicon from the wastewater, and
subsequent to contacting the wastewater with liquid sodium silicate LSS, treating the untreated water with an electrocoagulation apparatus for a period of time effective to at least partially remove silicon from the wastewater; and
and combinations thereof; and
giving a treated effluent;
where the untreated water contains more than about 200 mg/L boron and the treated effluent contains less than about 50 mg/L boron, and where the hardness of the wastewater taken as calcium carbonate (CaCO₃) is over 45,000 mg/L and the hardness of the treated effluent taken as CaCO₃ is below 40,000 mg/L.

20. The method of claim 19 where the effective amount of LSS ranges up to about 10% (v/v) of the wastewater volume.
